(19) United States
(12) Patent Application Publication
(10) Pub. No.: US 2022/0325201 A1
(43) Pub. Date: Oct. 13, 2022

(54) Cleaning Hydrophobic Soil from Textile

(71) Applicant: BASF SE, Ludwigshafen (DE)

(72) Inventors: Hannah Ferree, Wyandotte, MI (US); Ashish Taneja, Wyandotte, MI (US); Simone R. Bright, Wyandotte, MI (US)

(21) Appl. No.: 17/717,738

(22) Filed: Apr. 11, 2022

Related U.S. Application Data
(60) Provisional application No. 63/173,647, filed on Apr. 12, 2021.

(51) Int. Cl. C11D 1/825; C11D 1/72

(52) U.S. Cl. CPC C11D 1/8255; C11D 1/72

(57) ABSTRACT

The present invention relates to a method for reducing hydrophobic soil from a textile comprising the step of treating the textile with a cleaning composition comprising at least two surfactants selected from nonionic surfactants of general formula (I) and/or alkylpolyglycosides of general formula (II). The present invention further relates to a use of the cleaning composition for reducing hydrophobic soil from a textile.

### TECHNICAL FIELD

The present invention relates to a method for reducing hydrophobic soil from a textile comprising the step of treating the textile with a cleaning composition comprising at least two surfactants selected from nonionic surfactants of general formula (I) and/or alkylpolyglycosides of general formula (II). The present invention further relates to a use of the cleaning composition for reducing hydrophobic soil from a textile.

### BACKGROUND

Removing tough soils, particularly hydrophobic soil from a textile, especially heavily soiled towels is a tedious process. By the time these towels reach offsite commercial laundry locations, it is possible that they will be moldy and include various types of soils. It becomes difficult to clean them with commonly used surfactants alone and hence the clean requires high temperature and caustic. However, there is a market need and trend to move away from caustic due to its high corrosivity to metal and machine. Caustic also reduces the usable life of the textile.

Thus, it is an object of the presently claimed invention to provide a method for cleaning hydrophobic soil from textile, such as heavily soiled towels from restaurants, which does not involve use of caustic.

### Brief Summary of Some Example Embodiments

Surprisingly, a method for cleaning, employing a cleaning composition comprising certain non-ionic and/or alkylpolyglycoside reduces the hydrophobic soil effectively from the textile without the need of caustic.

Accordingly, in one aspect, the present invention is directed to a method for reducing hydrophobic soil from a textile comprising the step of
(I) treating the textile with a cleaning composition comprising
   (i) at least two surfactants selected from
      (a) nonionic surfactants of general formula (I)

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and a linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1; and/or
   (b) alkylpolyglycosides of general formula (II)

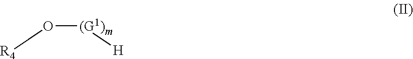

wherein
R₄ is a linear or branched, substituted or unsubstituted C₆ to C₃₀ alkyl,
G¹ is a monosaccharide residue having 5 or 6 carbon atoms, and
m is on average in the range of 1 to 10.

In another aspect, the present invention is directed to a use of the cleaning composition as described herein above, for reducing hydrophobic soil from a textile.

### DETAILED DESCRIPTION

Before the present compositions, concentrates and formulations of the invention are described, it is to be understood that this invention is not limited to particular compositions, concentrates and formulations described, since such compositions, concentrates and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Furthermore, the ranges defined throughout the specification include the end values as well, i.e. a range of 1 to 10, between 1 to 10 imply that both 1 and 10 are included in the range. For the avoidance of doubt, the applicant shall be entitled to any equivalents according to applicable law.

An aspect of the present invention is directed to a method for reducing hydrophobic soil from a textile comprising the step of
(I) treating the textile with a cleaning composition comprising
   (i) at least two surfactants selected from
   (a) nonionic surfactants of general formula (I)

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and a linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1; and/or
   (b) alkylpolyglycosides of general formula (II)

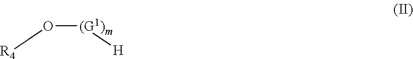

wherein
   R₄ is a linear or branched, substituted or unsubstituted C₆ to C₃₀ alkyl,
   G¹ is a monosaccharide residue having 5 or 6 carbon atoms, and
   m is on average in the range of 1 to 10.

By the term ‘hydrophobic soil’ it is meant oily and/or greasy soil.

The term ‘reducing’ herein means removal of more than 95% of the soil from the textile.

Nonionic Surfactants of General Formula (I)

The nonionic surfactants of general formula (I) have the following structure

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1;

Preferably the sum of x+y₁+z+y₂ is in the range of 1 to 50, more preferably the sum of x+y₁+z+y₂ is in the range of 1 to 40 even more preferably the sum of x+y₁+z+y₂ is in the range of 2 to 30 and most preferably the sum of x+y₁+z+y₂ is in the range of 2 to 25.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₁-C₂₂ alkyl 1 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₂₂ alkyl include, but are not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, 2-ethyl hexyl and t-butyl.

In an embodiment, R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2.

In an embodiment, R₁ is branched, unsubstituted C₁₃ alkyl, x is an integer in the range of 5 to 10, y₁ is 0, y₂ is 0, z is 0, R₂ is H, and wherein the sum of x+y₁+z+y₂ is at least 5.

In an embodiment, R₁ is branched, unsubstituted C₁₃ alkyl, x is an integer in the range of 2 to 5, y₁ is 0, y₂ is 0, z is 0, R₂ is H, and wherein the sum of x+y₁+z+y₂ is at least 2.

In an embodiment, R₁ is branched, unsubstituted C₁₃ alkyl, x is an integer in the range of 4 to 8, y₁ is 0, y₂ is 0, z is 0, R₂ is H, and wherein the sum of x+y₁+z+y₂ is at least 4.

In an embodiment, R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4.

In an embodiment, R₁ is linear and/or branched, unsubstituted C₁₂-C₁₄ alkyl, x is an integer in the range of 4 to 8, y₁ is 0, y₂ is 0, z is 0, R₂ is H, and wherein the sum of x+y₁+z+y₂ is at least 4.

In an embodiment, R₁ is linear or branched, unsubstituted C₁₃-C₁₅ alkyl, x is an integer in the range of 5 to 8, y₁ is 0, y₂ is 0, z is 0, R₂ is H, and wherein the sum of x+y₁+z+y₂ is at least 5.

In an embodiment, R₁ is linear, unsubstituted C₆ alkyl, x is an integer in the range of 4 to 8, y₁ is 0, y₂ is 0, z is 0, R₂ is H, and wherein the sum of x+y₁+z+y₂ is at least 4.

In an embodiment, R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1.

In an embodiment, R₁ is branched, unsubstituted C₁₀ alkyl, x=is 0, y₁=1 to 4, z=2-6, y₂=0, R₂ is H, R₃ is C₁ alkyl and wherein the sum of x+y₁+z+y₂ is at least 3.

In an embodiment, R₁ is branched, unsubstituted C₁₀ alkyl, x=is 0, y₁=5 to 10, z=0, y₂=0, R₂ is H, R₃ is C₁ alkyl and wherein the sum of x+y₁+z+y₂ is at least 5.

In an embodiment, R₁ is linear and/or branched, unsubstituted C₁₃-C₁₅ alkyl, x=is 5 to 10, y₁=1 to 5, z=0, y₂=0, R₂ is H, R₃ is C₂ alkyl and wherein the sum of x+y₁+z+y₂ is at least 6.

In an embodiment, R₁ is linear or branched, unsubstituted C₁₀-C₁₆ alkyl, x=is 4 to 10, y₁=0, z=0, y₂=0, R₂ is H, and wherein the sum of x+y₁+z+y₂ is at least 4.

In an embodiment, R₁ is branched, unsubstituted C₁₃ alkyl, x=is 4 to 8, y₁=0, z=0, y₂=0, R₂ is H, and wherein the sum of x+y₁+z+y₂ is at least 4.

In an embodiment, R₁ is branched, unsubstituted C₁₃ alkyl, x=is 6 to 10, y₁=0, z=0, y₂=0, R₂ is H, and wherein the sum of x+y₁+z+y₂ is at least 6.

In an embodiment, R₁ is branched, unsubstituted C₁₀ alkyl, x=is 0, y₁=5 to 10, z=0.5, y₂=0, R₂ is H, R₃ is C₁ alkyl and wherein the sum of x+y₁+z+y₂ is at least 5.

Suitable nonionic surfactants of the general formula (I) are as listed in Table-1

TABLE 1

| | R₁ | x | y₁ | z | y₂ | R₂ | R₃ |
|---|---|---|---|---|---|---|---|
| Surfactant 1 | C₁₃ branched, | 9 | 0 | 0 | 0 | H | — |
| | unsubstituted | | | | | | |
| Surfactant 2 | C₁₃ branched, | 3 | 0 | 0 | 0 | H | — |
| | unsubstituted | | | | | | |
| Surfactant 3 | C₁₃ branched, | 6 | 0 | 0 | 0 | H | — |
| | unsubstituted | | | | | | |
| Surfactant 4 | C₆ linear, | 5 | 0 | 0 | 0 | H | — |
| | unsubstituted | | | | | | |
| Surfactant 5 | C₁₃ branched, | 5 | 0 | 0 | 0 | H | — |
| | unsubstituted | | | | | | |
| Surfactant 6 | C₁₃ branched, | 8 | 0 | 0 | 0 | H | — |
| | unsubstituted | | | | | | |
| Surfactant 7 | C₁₃-C₁₅ linear | 9.8 | 2.1 | 0 | 0 | H | ethyl |
| | and branched, | | | | | | |
| | unsubstituted | | | | | | |
| Surfactant 8 | C₁₃-C₁₅ linear | 7 | 0 | 0 | 0 | H | — |
| | and branched, | | | | | | |
| | unsubstituted | | | | | | |
| Surfactant 9 | C₁₀ branched, | 0 | 2 | 5 | 0 | H | methyl |
| | unsubstituted | | | | | | |
| Surfactant 10 | C₁₂-C₁₄ linear | 6.5 | 0 | 0 | 0 | H | — |
| | and branched, | | | | | | |
| | unsubstituted | | | | | | |
| Surfactant 11 | C₁₀ branched, | 0 | 8 | 0 | 0 | H | methyl |
| | unsubstituted | | | | | | |
| Surfactant 11a | C₁₀ branched, | 0 | 8 | 0.5 | 0 | H | methyl |
| | unsubstituted | | | | | | |

Alkylpolyglycosides of General Formula (II)

Alkylpolyglycosides of general formula (II) have the following structure

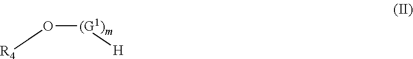

wherein
R₄ is a linear or branched, substituted or unsubstituted C₆ to C₃₀ alkyl,
G¹ is a monosaccharide residue having 5 or 6 carbon atoms, and
m is on average in the range of 1 to 10.

As used herein, the term “branched alkyl” is a radical of a saturated branched aliphatic group having an average number of branching of at least 0.7 as defined below. Preferably, the term “branched alkyl” refers to a radical of a saturated branched aliphatic group having an average number of branching of ranging from 0.9 to 3.5, more preferably ranging from 1.8 to 3.5 and most preferably from 2.0 to 2.5 as defined below. It is appreciated that the number of carbon atoms includes carbon atoms along the chain backbone as well as branching carbons.

As used herein, ‘average number of branches per molecule chain’ refers to the average number of branches per alcohol molecule which corresponds to the corresponding branched alkyl, as measured by ¹³C Nuclear Magnetic Resonance (¹³C NMR). The average number of carbon atoms in the chain are determined by gas chromatography.

Various references will be made throughout this specification and the claims to the percentage of branching at a given carbon position, the percentage of branching based on types of branches, average number of branches, and percentage of quaternary atoms. These amounts are to be measured and determined by using a combination of the following three ¹³C-NMR techniques.

(1) The first is the standard inverse gated technique using a 45-degree tip ¹³C pulse and 10 s recycle delay (an organic free radical relaxation agent is added to the solution of the branched alcohol in deuterated chloroform to ensure quantitative results). (2) The second is a J-Modulated Spin Echo NMR technique (JMSE) using a 1/J delay of 8 ms (J is the 125 Hz coupling constant between carbon and proton for these aliphatic alcohols). This sequence distinguishes carbons with an odd number of protons from those bearing an even number of protons, i.e. CH₃/CH vs CH₂/Cq (Cq refers to a quaternary carbon) (3) The third is the JMSE NMR “quat-only” technique using a 12 J delay of 4 ms which yields a spectrum that contains signals from quaternary carbons only. The JSME NMR quat only technique for detecting quaternary carbon atoms is sensitive enough to detect the presence of as little at 0.3 atom % of quaternary carbon atoms. As an optional further step, if one desires to confirm a conclusion reached from the results of a quat only JSME NMR spectrum, one may also run a DEPT-135 NMR sequence. The DEPT-135 NMR sequence may be very helpful in differentiating true quaternary carbons from breakthrough protonated carbons. This is due to the fact that the DEPT-135 sequence produces the “opposite” spectrum to that of the JMSE “quat-only” experiment. Whereas the latter nulls all signals except for quaternary carbons, the DEPT-135 nulls exclusively quaternary carbons. The combination of the two spectra is therefore very useful in spotting non quaternary carbons in the JMSE “quat only” spectrum. When referring to the presence or absence of quaternary carbon atoms throughout this specification, however, it is meant that the given amount or absence of the quaternary carbon is as measured by the quat only JSME NMR method. If one optionally desires to confirm the results, then also using the DEPT-135 technique to confirm the presence and amount of a quaternary carbon.

For example, the branched C₁₃-alkyl has an average number of branching of from 0.9 to 3.5, more preferably ranging from 1.8 to 3.5 and most preferably from 2.0 to 2.5. The number of branching is defined as the number of methyl groups in one molecule of the corresponding alcohol of the branched alkyl minus 1. The average number of branching is the statistical average of the number of branching of the molecules of a sample.

The branched alkyl can be characterized by the NMR technique as having from 5 to 25% branching on the C₂ carbon position, relative to the ether group. In a preferred embodiment, from 10 to 20% of the number of branches are at the C₂ position, as determined by the NMR technique. The branched alkyl also generally has from 10% to 50% of the number of branches on the C₃ position, more typically from 15% to 30% on the C₃ position, also as determined by the NMR technique. When coupled with the number of branches seen at the C₂ position, the branched alkyl in this case contain significant amount of branching at the C₂ and C₃ carbon positions.

Thus, the branched alkyl of the present invention has a significant number of branches at the C₂ and C₃ positions. Additionally, or alternatively, the branched alkyl preferably has ≥7%, more preferably ≤5%, of isopropyl terminal type of branching, as determined by the NMR technique, meaning methyl branches at the second to last carbon position in the backbone relative to the ether group.

In one embodiment, the branching occurs across the length of the carbon backbone. It is however preferred that at least 20%, more preferably at least 30%, of the branches are concentrated at the C₂, C₃, and isopropyl positions. Alternatively, the total number of methyl branches number is at least 40%, even at least 50%, of the total number of branches, as measured by the NMR technique described above. This percentage includes the overall number of methyl branches seen by the NMR technique described above within the C₁ to the C₃ carbon positions relative to the ether group, and the terminal isopropyl type of methyl branches.

The term “unsubstituted” means that the branched alkyl group is free of substituents, i.e. the branched alkyl group is composed of carbon and hydrogen atoms only.

In one embodiment, the two or more compounds of the composition differ in R₄. Preferably, the composition comprises a mixture of two or more compounds of the general formula (II) differing in R₄, while G¹ and m are the same. If two or more compounds of the composition differ in R₄, R₄ may differ in the number of carbon atoms (i.e. the length) or the kind of branching.

For example, if the two or more compounds of the composition differ in the number of carbon atoms (i.e. the length), one of the two or more compounds is a compound, wherein R₄ is unsubstituted branched C₉-alkyl, and one or more compound(s) of the two or more compounds is a compound, wherein R₄ is unsubstituted branched C₁₀-alkyl, unsubstituted branched C₁₁-alkyl, unsubstituted branched C₁₂-alkyl and/or unsubstituted branched C₁₃-alkyl.

Alternatively, if the two or more compounds of the composition differ in the kind of branching, it is appreciated that the two or more compounds are compounds having the same number of carbon atoms (i.e. the length), but the branching across the length of the carbon backbone is different. For example, each of the two or more compounds are unsubstituted branched C₁₃-alkyl, wherein R₄ differs in the branching across the length of the carbon backbone. Accordingly, R₄ is a mixture of different unsubstituted branched C₉-C₁₃-alkyl.

If R₄ is a mixture of different unsubstituted branched C₉-C₁₅ alkyl, it is appreciated that it is not excluded that the composition comprises minor amounts of R₄ being unsubstituted straight-chain C₉-C₁₅ alkyl, i.e. C₉-C₁₅ alkyl being free of branches. For example, the composition comprising two or more compounds of the general formula (II), comprises one or more compounds, wherein R₄ is unsubstituted straight-chain C₉-C₁₅ alkyl, in an amount of ≥1.0 wt.-%, based on the total weight of the composition.

Preferably, the two or more compounds of the composition differ in R₄.

The two or more compounds of the general formula (II) are preferably obtained by the corresponding glycosylation of a mixture of alcohols. It is to be noted that the mixture of alcohols is preferably obtained by hydroformylating and optionally hydrogenation of a trimer butene or a tetramer propene, more preferably of a trimer butene. A process for preparing the mixture of alcohols is e.g. described in WO 2001/36356 A2.

In the general formula (II), G¹ is selected from monosaccharides with 5 or 6 carbon atoms. For example, G¹ is selected from pentoses, and hexoses. Examples of pentoses are ribulose, xylulose, ribose, arabinose, xylose and lyxose. Examples of hexoses are galactose, mannose, rhamnose and glucose. Monosaccharides may be synthetic or derived or isolated from natural products, hereinafter in brief referred to as natural saccharides or natural polysaccharides, and natural saccharides natural polysaccharides being preferred. More preferred are the following natural monosaccharides: glucose, xylose, arabinose, rhamnose and mixtures of the foregoing, even more preferred are glucose and/or xylose, and in particular xylose. Monosaccharides can be selected from any of their enantiomers, naturally occurring enantiomers and naturally occurring mixtures of enantiomers being preferred. Naturally, in a specific molecule only whole groups of G¹ can occur.

Thus, if G¹ in the general formula (II) is a pentose, the pentose may be selected from ribulose such as D-ribulose, L-ribulose and mixtures thereof, preferably D-ribulose, xylulose such as D-xylulose, L-xylulose and mixtures thereof, preferably D-xylulose, ribose such as D-ribose, L-ribose and mixtures thereof, preferably D-ribose, arabinose such as D-arabinose, L-arabinose and mixtures thereof, preferably L-arabinose, xylose such as D-xylose, L-xylose and mixtures thereof, preferably D-xylose and lyxose such as D-lyxose, L-lyxose and mixtures thereof, preferably D-lyxose. If G¹ in the general formula (II) is a hexose, the hexose may be selected from galactose such as D-galactose, L-galactose and mixtures thereof, preferably D-galactose, mannose such as D-mannose, L-mannose and mixtures thereof, preferably D-mannose, rhamnose such as D-rhamnose, L-rhamnose and mixtures thereof, preferably L-rhamnose and glucose such as D-glucose, L-glucose and mixtures thereof, preferably D-glucose. More preferably, G¹ in the general formula (II) is glucose, preferably D-glucose, xylose, preferably D-xylose, arabinose, preferably D-arabinose, rhamnose, preferably L-rhamnose, and mixtures of the foregoing, even more preferably G¹ in the general formula (II) is glucose, preferably D-glucose and/or xylose, preferably D-xylose, and/or arabinose, preferably D-arabinose, and in particular xylose, preferably D-xylose and/or arabinose, preferably D-arabinose. For example, G¹ in the general formula (II) is xylose, preferably D-xylose or arabinose, preferably D-arabinose.

In one embodiment, G¹ is selected from monosaccharides with 5 or 6 carbon atoms, which are obtained from a fermentative process of a biomass source. The biomass source may be selected from the group comprising pine wood, beech wood, wheat straw, corn straw, switchgrass, flax, barley husk, oat husk, bagasse, miscanthus and the like.

Thus, it is appreciated that G¹ can comprise a mixture of monosaccharides with 5 or 6 carbon atoms.

Preferred mixtures of monosaccharides with 5 or 6 carbon atoms include, but are not limited to, a mixture of xylose and glucose or a mixture of xylose and arabinose and optionally glucose. Thus, G¹ is preferably a mixture of xylose and glucose or a mixture of xylose and arabinose and optionally glucose.

If the mixture of monosaccharides with 5 or 6 carbon atoms comprises a mixture of glucose and xylose, the weight ratio of glucose to xylose may vary in a wide range, depending on the biomass source used. For example, if the mixture of monosaccharides with 5 or 6 carbon atoms comprises a mixture of glucose and xylose, the weight ratio of glucose to xylose (glucose [wt.-%]/xylose [wt.-%]) in the mixture is preferably from 20:1 to 1:10, more preferably from 10:1 to 1:5, even more preferably from 5:1 to 1:2 and most preferably from 3:1 to 1:1.

If the mixture of monosaccharides with 5 or 6 carbon atoms comprises a mixture of xylose and arabinose, the weight ratio of xylose to arabinose may vary in a wide range, depending on the biomass source used. For example, if the mixture of monosaccharides with 5 or 6 carbon atoms comprises a mixture of xylose and arabinose, the weight ratio of xylose to arabinose (xylose [wt.-%]/arabinose [wt.-%]) in the mixture is preferably from 150:1 to 1:10, more preferably from 100:1 to 1:5, even more preferably from 90:1 to 1:2 and most preferably from 80:1 to 1:1.

If the mixture of monosaccharides with 5 or 6 carbon atoms comprises a mixture of glucose and xylose and arabinose, the weight ratio of glucose to xylose to arabinose may vary in a wide range, depending on the biomass source used. For example, if the mixture of monosaccharides with 5 or 6 carbon atoms comprises a mixture of glucose and xylose and arabinose, the weight ratio of glucose to arabinose (glucose [wt.-%]/arabinose [wt.-%]) in the mixture is preferably from 220:1 to 1:20, more preferably from 200:1 to 1:15, even more preferably from 190:1 to 1:10 and most preferably from 180:1 to 1:8. Additionally or alternatively, the weight ratio of xylose to arabinose (xylose [wt.-%]/arabinose [wt.-%]) in the mixture is preferably from 150:1 to 1:20, more preferably from 120:1 to 1:15, even more preferably from 100:1 to 1:10 and most preferably from 80:1 to 1:8. Additionally or alternatively, the weight ratio of glucose to xylose (glucose [wt.-%]/xylose [wt.-%]) in the mixture is preferably from 150:1 to 1:20, more preferably from 120:1 to 1:15, even more preferably from 100:1 to 1:10 and most preferably from 80:1 to 1:8.

In one embodiment, especially if G¹ is obtained from a fermentative process of a biomass source, G¹ may comprise minor amounts of monosaccharides differing from the monosaccharides with 5 or 6 carbon atoms.

Preferably, G¹ comprises ≥10 wt.-%, more preferably ≤5 wt.-%, based on the total weight of the monosaccharide, of monosaccharides differing from the monosaccharides with 5 or 6 carbon atoms. That is to say, G¹ comprises ≥90 wt.-%, more preferably ≥95 wt.-%, based on the total weight of the monosaccharide, of the monosaccharides with 5 or 6 carbon atoms.

In the general formula (II), m (also named degree of polymerization (DP)) is in the range of from 1 to 10, preferably m is in the range of from 1.05 to 2.5 and most preferably m is in the range of from 1.10 to 1.8, e.g. from 1.1 to 1.4. In the context of the present invention, m refers to average values, and m is not necessarily a whole number. In a specific molecule only whole groups of G¹ can occur. It is preferred to determine m by high temperature gas chromatography (HTGC), e.g. 400° C., in accordance with K. Hill et al., Alkyl Polyglycosides, VCH Weinheim, N.Y., Basel, Cambridge, Tokyo, 1997, in particular pages 28 ff., or by HPLC. In HPLC methods, m may be determined by the Flory method. If the values obtained by HPLC and HTGC are different, preference is given to the values based on HTGC. In an embodiment, G¹ is selected from glucose, xylose, arabinose, rhamnose, and mixtures thereof.

It is appreciated that the compounds of the general formula (II) can be present in the alpha and/or beta conformation. For example, the compound of general formula (II) is in the alpha or beta conformation, preferably alpha conformation. Alternatively, the compound of general formula (II) is in the alpha and beta conformation.

If the compound of general formula (II) is in the alpha and beta conformation, the compound of general formula (II) comprise the alpha and beta conformation preferably in a ratio (a/13) from 10:1 to 1:10, more preferably from 10:1 to 1:5, even more preferably from 10:1 to 1:4 and most preferably from 10:1 to 1:3, e.g. about 2:1 to 1:2. In an embodiment, m is in the range of 1.05 to 2.5.

In an embodiment, R₄ is a linear or branched, unsubstituted C₆ to C₂₀ alkyl.

In a preferred embodiment, R₄ is a linear, unsubstituted C₈ to C₁₄ alkyl.

In a more preferred embodiment, R₄ is a linear, unsubstituted C₈ to C₁₂ alkyl.

In an embodiment, R₄ is a branched, unsubstituted C₉ to C₁₅ alkyl.

In a preferred embodiment, R₄ is a branched, unsubstituted C₉ to C₁₃ alkyl.

In a more preferred embodiment, R₄ is a branched, unsubstituted C₉ or C₁₀ or C₁₃ alkyl.

In a most preferred embodiment, R₄ is a linear, unsubstituted C₁₂ alkyl branched, and branched, unsubstituted C₁₀ or C₁₃ alkyl.

In a most preferred embodiment, m is in the range of 1.10 to 1.8.

Suitable alkylpolyglycosides of general formula (II) are as listed in Table 2

TABLE 2

| | R₄ | G¹ | m |
|---|---|---|---|
| Surfactant 12 | C₁₃ branched, | Glucose | 1.5 |
| | unsubstituted | | |
| Surfactant 13 | C₁₂-C₁₄ linear, | Glucose | 1.5 |
| | unsubstituted | | |

Method

The present invention is directed to a method for reducing hydrophobic soil from the textile.

In an embodiment, the term textile refers to towels, wipes and cloth dusters used in restaurants to wipe the counters and/or clean the floor.

In an embodiment, the present invention is directed to a method for reducing oil and/or grease from towels, wipes and cloth dusters used in restaurants to wipe the counters and/or clean the floor.

In an embodiment, the textile is made of fibers selected from the group of natural fibers and synthetic fibers.

In a preferred embodiment, the textile is made of synthetic fibers.

In an embodiment, the synthetic fibers are selected from the group of polyurethane fibers, polyester fibers, polyolefins, polyamide fibers and mixtures thereof.

Examples of synthetic fibers are polyurethane fibers such as Spandex® or Lycra®, polyester fibers, polyolefins such as elastofin and polyamide fibers such as nylon. Fibers may be single fibers or parts of textiles such as wovens, or nonwovens.

In a preferred embodiment, the cleaning composition is free of alkali metal hydroxide.

By the term ‘free’ it is meant that the method does not contain alkali metal hydroxide more than 0.001%, by weight of the final weight of the composition.

In an embodiment, the method for reducing hydrophobic soil from a textile comprises the step of treating the textile with a cleaning composition comprising at least two surfactants selected from

(a1) a first nonionic surfactant of formula (I); and
(a2) a second nonionic surfactant of formula (I)
where said nonionic surfactant (a1) is different from a2; and
wherein the weight ratio of said nonionic surfactants (a1) to (a2) is in the range of 1:1 to 2:1.

In an embodiment, for (a1) the first nonionic surfactant of general formula (I) R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2.

In an embodiment, for (a2) the second nonionic surfactant of general formula (I) R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4.

In an embodiment, the method for reducing hydrophobic soil from a textile comprises the step of treating the textile with a cleaning composition comprising at least three surfactants selected from

(a1) a first nonionic surfactant of formula (I),
(a2) a second nonionic surfactant of formula (I); and
(a3) a third nonionic surfactant of formula (I)
where the nonionic surfactants (a1), (a2) and (a3) are different from each other; and
wherein the weight ratio of said nonionic surfactants (a1) to (a2) to (a3) is in the range of 1:1:1 to 1:3:3.

In an embodiment, for (a3) the third nonionic surfactant of formula (I), R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1.

In an embodiment, the method for reducing hydrophobic soil from a textile comprises the step of treating the textile with a cleaning composition comprising at least three surfactants selected from

(a1) a first nonionic surfactant of formula (I); and
(a2) a second nonionic surfactant of formula (I)
where nonionic surfactant (a1) is different from (a2).

In an embodiment, the method for reducing hydrophobic soil from a textile comprises the step of treating the textile with a cleaning composition comprising at least two surfactants selected from

(a1) nonionic surfactant of formula (I); and
(b1) an alkylpolyglycoside of general (II)
wherein the weight ratio of (a1) to (b1) is in the range of 1:1 to 4:1.

In an embodiment, for (b1) an alkylpolyglycoside of general formula (II) R₄ is a linear or branched, unsubstituted C₁₀ to C₁₄ alkyl, G¹ is a monosaccharide residue having 6 carbon atoms, m is on average in the range of 1.05 to 2.5.

In an embodiment, the cleaning composition further comprises at least one additive.

In another aspect, the present invention is directed to a cleaning composition comprising at least two surfactants selected from
(a1) a first nonionic surfactant of formula (I), wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2; and
(a2) a second nonionic surfactant of formula (I), wherein R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4; and
where said nonionic surfactant (a1) is different from (a2).

In an embodiment, the weight ratio of the first nonionic surfactant (a1) to the second nonionic surfactant (a2) is in the range of 1:1 to 2:1.

In an embodiment, the cleaning composition comprises at least three surfactants selected from
(a1) a first nonionic surfactant of formula (I) wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2,
(a2) a second nonionic surfactant of formula (I), wherein R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4; and
(a3) a third nonionic surfactant of formula (I), wherein R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1; and
where the nonionic surfactants (a1), (a2) and (a3) are different from each other.

In another embodiment, the weight ratio of said nonionic surfactants (a1) to (a2) to (a3) is in the range of 1:1:1 to 1:3:3.

In an embodiment, the cleaning composition comprises at least two surfactants selected from
(a1) nonionic surfactant of formula (I) wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2; and
(b1) an alkylpolyglycoside of general (II), R₄ is a linear or branched, unsubstituted C₁₀ to C₁₄ alkyl, G¹ is a monosaccharide residue having 6 carbon atoms, m is on average in the range of 1.05 to 2.5.

In an embodiment, the weight ratio of nonionic surfactants (a1) and the alkylpolyglycoside (b1) is in the range of 1:1 to 4:1.

Additive

In an embodiment, the at least one additive is selected from chelating agents, enzymes, builders, bleaching agents, fragrances and fillers.

Chelating Agents

The cleaning composition according to the method of the presently claimed invention may include a chelating/sequestering agent such as an aminocarboxylic acid, a condensed phosphate, a phosphonate and a polyacrylate. In general, a chelating agent is a molecule capable of coordinating (i.e., binding) the metal ions commonly found in natural water to prevent the metal ions from interfering with the action of the other detersive ingredients of a cleaning composition. Useful aminocarboxylic acids include, for example, n-hydroxyethyliminodiacetic acid, nitrilotriacetic acid (NTA), ethylenediaminetetraacetic acid (EDTA), N-hydroxyethyl ethylenediaminetriacetic acid (HEDTA), diethylenetriamine pentaacetic acid (DTPA), methylglycinediacetic acid (MGDA) and glutamic acid diacetic acid (GLDA). Examples of condensed phosphates are sodium and potassium orthophosphate, sodium and potassium pyro-phosphate, sodium tripolyphosphate and sodium hexametaphosphate.

Enzymes

Enzymes can be added to the cleaning composition according to the method of the presently claimed invention for a wide variety of fabric laundering purposes, including removal of protein-based, carbohydrate-based, or triglyceride-based stains and for the prevention of refugee dye transfer as well as for fabric restoration. Preferred enzymes are selected from cellulases, proteases, amylases, lipases and mixtures thereof. The choice of the enzymes is governed by several factors such as the pH-activity and/or stability optima, the thermostability, the stability versus active detergents and the builders. Along with enzymes, enzyme stabilizing systems may also be used, such as for example, calcium ions, boric acid, boronic acids, propylene glycol and short chain carboxylic acids.

Builders

The cleaning composition according to the method of the presently claimed invention may also include a detergent builder to assist in controlling mineral hardness. Inorganic or phosphorus-containing detergent builders include, but are not limited to, the alkali metal, ammonium and alkanol ammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates.

Examples of silicate builders are the alkali metal silicates, particularly those having a SiO₂:Na₂O ratio from 1.6:1 to 3.2:1 and the layered silicates.

Examples of carbonate builders are the alkaline earth and alkali metal carbonates. Aluminosilicate builders are of great importance.

Useful aluminosilicate ion exchange materials are commercially available. These aluminosilicates can be crystalline or amorphous in structure and can be naturally occurring aluminosilicates or synthetically derived. Synthetic crystalline aluminosilicate ion exchange materials are available under the designations Zeolite A, Zeolite P (B), Zeolite MAP and Zeolite X.

Organic detergent builders include a wide variety of polycarboxylate compounds. As used herein, “polycarboxylate” refers to compounds having a plurality of carboxylate groups, prefer-ably at least 3 carboxylates. Polycarboxylate builder can generally be added to the composition in acid form but can also be added in the form of a neutralized salt. When utilized in the salt form, alkali metals, such as sodium, potassium, lithium and alkanolammonium salts are preferred.

One important category of polycarboxylate builders encompasses the ether polycarboxylates, including oxydisuccinate. Suitable ether polycarboxylates also include cyclic compounds, particularly alicyclic compounds.

Other useful detergency builders include the ether hydroxypolycarboxylates, copolymers of maleic anhydride with ethylene or vinyl methyl ether, 1,3,5-trihydroxybenzene-2,4,6-trisulphonic acid and carboxymethyloxysuccinic acid, the various alkali metal, ammonium and substituted ammonium salts of polyacetic acids such as ethylenediamine tetraacetic acid, methylglycinediacetic acid (MGDA) and nitrilotriacetic acid, as well as polycarboxylates such as mellitic acid, succinic acid, oxydisuc-cinic acid, polymaleic acid, benzene 1,3,5 tricarboxylic acid, carboxymethyloxysuccinic acid, and soluble salts thereof. Citrate builders, e.g., citric acid and soluble salts thereof (particular-ly sodium salt), are polycarboxylate builders of importance for liquid detergent formulations due to their availability from renewable resources and their biodegradability. Citrates can also be used in granular compositions, especially in combination with zeolite and/or layered silicate builders. Fatty acids, e.g., C₁₂-C₁₈ monocarboxylic acids, can also be incorporated into the compositions alone, or in combination with the aforementioned builders, especially citrate and/or the succinate builders, to provide additional builder activity.

Bleaching Agents

The bleaching agents may be bleach catalysts or bleach activators and combinations thereof.

The cleaning composition according to the method of the presently claimed invention may comprise one or more bleach catalysts. Bleach catalysts can be selected from the group of oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and cobalt-, iron-, copper- and ruthenium-amine complexes.

The cleaning composition according to the method of the presently claimed invention can comprise one or more bleach activators, for example, tetraacetyl ethylene diamine, tetraacetylmethylene diamine, tetraacetylglycoluril, tetraacetylhexylenediamine, acylated phenolsulfonates such as for example n-nonanoyloxybenzene sulfonates or isononanoyloxybenzene sulfonates, N-methylmorpholinium acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHF”) or nitrile quats (trimethylammonium acetonitrile salts).

Fragrances

Suitable fragrances are those derived from natural sources or are synthetic aromatic substances. Natural aromatic substances are, for example, extracts from blossom (lilies, lavender, roses, jasmine, neroli, ylang-ylang), from stems and leaves (geranium, patchouli, petitgrain), from fruit (aniseed, coriander, carraway, juniper), from fruit peel (bergamot, lemons, oranges), from roots (mace, angelica, celery, cardamom, costus, iris, calmus), from wood (pinewood, sandalwood, guaiacum wood, cedarwood, rose-wood), from herbs and grasses (tarragon, lemon grass, sage, thyme), from needles and twigs (spruce, pine, scots pine, mountain pine), from resins and balsams (galbanum, elemi, benzoin, myrrh, olibanum, opoponax). Typical synthetic aromatic substances are, for example, products of the ester, ether, aldehyde, ketone, alcohol or hydrocarbon type. Aromatic substance compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals having from 8 to 18 hydrocarbon atoms, citral, citronellal, citronellyl oxyacetaldehyde, cyclamen aldehyde, hydroxy citronellal, lilial and bourgeonal; the ketones include, for example, the ionones, isomethylionone and methyl cedryl ketone; the alcohols include, for example, anethol, citronellol, eugenol, isoeugenol, geraniol, linalool, phenyl ethyl alcohol and terpinol; and the hydrocarbons include mainly the terpenes and balsams. Ethereal oils of relatively low volatility, which are chiefly used as aroma components, are also suitable for fragrance, e.g. sage oil, camomile oil, clove oil, melissa oil, oil of cinnamon leaves, lime blossom oil, juniper berry oil, vetiver oil, olibanum oil, galbanum oil, labolanum oil and lavandin oil.

Fillers

The cleaning composition according to the method of the presently claimed invention may also include a filler which does not perform as a cleaning agent per se but cooperates with the cleaning agent to enhance the overall cleaning capacity of the composition. Examples of fillers are, but not limited to, sodium sulfate, sodium chloride, starch and sugars.

In another aspect, the present invention is directed to a use of the cleaning composition as described herein above, for reducing hydrophobic soil from a textile.

In an embodiment, the present invention is directed to a use of the cleaning composition as described herein above, for reducing oil and/or grease from a textile.

In an embodiment, the present invention is directed to a use of the cleaning composition as described herein above, for reducing oil and/or grease from towels, wipes and cloth dusters used in restaurants to wipe the counters and/or clean the floor.

The method of the present invention offers one or more of following advantages

(1) Caustic-free cleaning method.

(2) Method is applicable on commercial scale.

### Embodiments

The present invention is illustrated in more detail by the following embodiments and combinations of embodiments which result from the corresponding dependency references and links:
1. A method for reducing hydrophobic soil from a textile comprising the step of
   (I) treating the textile with a cleaning composition comprising
      (i) at least two surfactants selected from
      (a) nonionic surfactants of general formula (I)

R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂alkyl,
A is CH₂—CH₂—O,
B is CH₂—CHR₃—O, wherein R₃ is selected from H and a linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1; and/or
(b) alkylpolyglycosides of general formula (II)

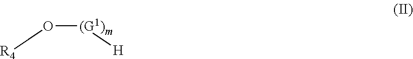

wherein
R₄ is a linear or branched, substituted or unsubstituted C₆ to C₃₀ alkyl,
G¹ is a monosaccharide residue having 5 or 6 carbon atoms, and
m is on average in the range of 1 to 10.
2. The method according to embodiment 1, wherein R₄ is a linear, unsubstituted C₆ to C₁₄ alkyl.
3. The method according to embodiment 1, wherein G¹ is selected from glucose, xylose, arabinose, rhamnose, and mixtures thereof.
4. The method according to embodiment 1, wherein m is in the range of 1.05 to 2.5.
5. The method according to embodiment 1, wherein m is in the range of 1.10 to 1.8.
6. The method according to embodiment 1, wherein the textile is made of fibers selected from group of natural fibers and synthetic fibers.
7. The method according to embodiment 6, wherein the textile is made of synthetic fibers.
8. The method according to embodiment 6 or 7, wherein the synthetic fibers are selected from group of polyurethane fibers, polyester fibers, polyolefins and polyamide fibers.
9. The method according to one or more of embodiments 1 to 8, wherein the cleaning composition is free of alkali metal hydroxide.
10. The method according to one or more of embodiments 1 to 9, wherein the cleaning composition comprises at least two surfactants selected from
   (a1) a first nonionic surfactant of formula (I); and
   (a2) a second nonionic surfactant of formula (I)
   where (a1) is different from (a2); and
   wherein the weight ratio of the said nonionic surfactant (a1) to (a2) is in the range of 1:1 to 2:1.
11. The method according to embodiment 10, wherein for (a1) the first nonionic surfactant of general formula (I) R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2.
12. The method according to embodiment 10, wherein for (a2) the second nonionic surfactant of general formula (I) R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4.
13. The method according to one or more of embodiments 1 to 9, wherein the cleaning composition comprises at least three surfactants selected from
   (a1) a first nonionic surfactant of formula (I),
   (a2) a second nonionic surfactant of formula (I); and
   (a3) a third nonionic surfactant of formula (I)
   where the nonionic surfactants (a1), (a2) and (a3) are different from each other; and
   wherein the weight ratio of said nonionic surfactants (a1) to (a2) to (a3) is in the range of 1:1:1 to 1:3:3.
14. The method according to embodiment 13, wherein for (a2) the third nonionic surfactant of formula (I), R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1.
15. The method according to one or more of embodiments 1 to 9, wherein the cleaning composition comprises at least two surfactants selected from
   (a1) nonionic surfactant of formula (I),
   (b1) an alkylpolyglycoside of general (II), and
   wherein the weight ratio of (a1) to (b1) is in the range of 1:1 to 4:1.
16. The method according to embodiment 15, wherein for (b1) an alkylpolyglycoside of general formula (II) R₄ is a linear or branched, unsubstituted C₁₀ to C₁₄ alkyl, G¹ is a monosaccharide residue having 6 carbon atoms, m is on average in the range of 1.05 to 2.5.
17. The method according to one or more of embodiments 1 to 16, wherein the cleaning composition further comprises at least one additive.
18. The method according to embodiment 17, wherein the at least one additive is selected from chelating agents, enzymes, builders, bleaching agents, fragrances, and fillers.
19. Use of the cleaning composition according to one or more of embodiments 1 to 18 for reducing hydrophobic soil from a textile.
20. The method according to one or more of embodiments 1 to 18 or use according to embodiment 19 wherein the hydrophobic soil is oil and/or grease.
21. The method according to one or more of embodiments 1 to 18 or use according to embodiment 19 wherein the textile is selected from towel and wipes.
22. A cleaning composition comprising at least two surfactants selected from
   (a1) a first nonionic surfactant of formula (I), wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2; and
   (a2) a second nonionic surfactant of formula (I), wherein R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4; and
   where said nonionic surfactant (a1) is different from (a2).
23. The cleaning composition according to embodiment 22, wherein the weight ratio of the first nonionic surfactant (a1) to the second nonionic surfactant (a2) is in the range of 1:1 to 2:1.
24. A cleaning composition comprising at least three surfactants selected from
   (a1) a first nonionic surfactant of formula (I) wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2,
   (a2) a second nonionic surfactant of formula (I), wherein R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4; and
   (a3) a third nonionic surfactant of formula (I), wherein R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1; and
   where the nonionic surfactants (a1), (a2) and (a3) are different from each other.
25. The cleaning composition according to embodiment 24, wherein the weight ratio of said nonionic surfactants (a1) to (a2) to (a3) is in the range of 1:1:1 to 1:3:3.
26. A cleaning composition comprising at least two surfactants selected from
   (a1) nonionic surfactant of formula (I) wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2; and
   (b1) an alkylpolyglycoside of general (II), R₄ is a linear or branched, unsubstituted C₁₀ to C₁₄ alkyl, G¹ is a monosaccharide residue having 6 carbon atoms, m is on average in the range of 1.05 to 2.5; and
   wherein the weight ratio of (a1) to (b1) is in the range of 1:1 to 4:1.
27. The cleaning composition according to embodiment 26, wherein the weight ratio of said nonionic surfactants (a1) to the alkylpolyglycoside is in the range of 1:1:1 to 1:3:3.

### EXAMPLES

Compounds

Suitable surfactants of the general formula (I) and (II), are as listed in Table-1 and Table-2.

Surfactant Blends

Table-3: Inventive surfactant blends 1 to 10

TABLE 3

| | First Non- | Second Non- | Third Non- | | |
|---|---|---|---|---|---|
| | ionic | ionic | ionic | | |
| Inventive | surfactant of | surfactant of | surfactant of | alkylpolyglycoside | |
| surfactant | general | general | general | of general | Weight ratio of |
| blend | formula (I) | formula (I) | formula (I) | formula (II) | surfactants |
| 1 | Surfactant 3 | Surfactant 10 | Surfactant 9 | | 1:1:2 |
| 2 | Surfactant 1 | Surfactant 10 | | | 1:1 |
| 3 | Surfactant 3 | Surfactant 10 | Surfactant 11 | | 1.5:1.5:1 |
| 4 | Surfactant 2 | Surfactant 8 | | | 1:1 |
| 5 | Surfactant 1 | | | Surfactant 13 | 1:1 |
| 6 | Surfactant 1 | | | Surfactant 13 | 2:1 |
| 7 | Surfactant 3 | Surfactant 4 | | | 3:2 |
| 8 | | Surfactant 7 | Surfactant 6 | | 1:2:2 |
| | | | and | | |
| | | | Surfactant 5 | | |
| 9 | Surfactant 1 | | | Surfactant 12 | 1:1 |
| 10 | Surfactant 3 | Surfactant 10 | Surfactant 11A | | 1.5:1.5:1 |

For a cleaning composition comprising inventive surfactant blends 1 to 10 the cleaning performance was rated. The results are as follows in Table-4.

### Measurement of Cleaning Performance

The pieces of bar towel were categorized based on how heavily soiled they were before being washed (light, moderate, and heavy). Lightly soiled indicates small areas of towel or parts of the towel were covered in a light soil load and some parts of the towel are not soiled. Moderately soiled indicates some more densely soiled areas of towel and some parts of the towel may not have much to any soil. Heavy soil indicates parts of the bar towel were soiled with soils densely covering the towel. Most of the piece of towel had a soil load. The towels were soiled with different soils such as oil, grease and food particles. They were then treated with the washing composition comprising surfactant blends according to Table-3.

After washing, pieces of bar towel were rated on a scale of 1 to 10 by visual inspection, 1 being the cleanest, 10 the most heavily soiled, so the change in cleaning is the difference between the ratings before and after washing. The results are as follows in Table-4.

TABLE 4

| | | | Moderate | |
|---|---|---|---|---|
| | | Light Soil | Soil | Heavy Soil |
| | | Change in | Change in | Change in |
| Example no. | Surfactant/blend | cleaning | cleaning | cleaning |
| Comparative | Surfactant 10 + | 2.5 | 3.0 | 3.5 |
| Ex.1 | NaOH | | | |
| Comparative | Surfactant 10 | 2.5 | 2.5 | 3.0 |
| Ex.2 | only | | | |
| Ex.1 | Blend 3 + Non- | — | 3.5 | 4.5 |
| | caustic builder¹ | | | |
| Ex.2 | Blend 7 + Non- | — | 4.5 | 5.0 |
| | caustic builder¹ | | | |
| Ex.3 | Blend 9 + Non- | — | 3.75 | 5.5 |
| | caustic builder¹ | | | |
| Ex. 4 | Blend 10 + Non- | 2.5 | 3.5 | — |
| | caustic builder¹ | | | |

¹Non-caustic builder - Aqueous solution of trisodium salt of methylglycinediacetic acid (Na3MGDA) and liquid sodium silicate having ratio as 1:1

After washing, pieces of bar towel were rated on a scale of 1 to 10 by visual inspection, 1 being the cleanest, 10 the light soiled, so the change in cleaning is the difference between the ratings before and after washing. The results are as follows in Table-5.

TABLE 5

| | | | Moderate | |
|---|---|---|---|---|
| | | Light Soil | Soil | Heavy Soil |
| | | Change in | Change in | Change in |
| Example no. | Surfactant/blend | cleaning | cleaning | cleaning |
| Comparative | Surfactant 10 + non- | — | 3.25 | 3.5 |
| Ex.3 | caustic builder¹ | | | |
| Comparative | non-caustic builder¹ | — | 3.5 | — |
| Ex.4 | | | | |
| Comparative | Caustic builder² | 3 | 3 | — |
| Ex.5 | | | | |
| Ex.5 | Blend 10 | — | 4 | 4 |
| Ex.6 | Blend 7 | — | 4 | 3.75 |
| Ex.7 | Blend 9 | — | 3.5 | 3.5 |

¹Non-caustic builder - Non-caustic builder - Aqueous solution of trisodium salt of methylglycinediacetic acid (Na3MGDA) and liquid sodium silicate having ratio as 1:1
²Caustic builder - 2000 ppm NaOH

A higher difference indicates a better cleaning. The cleaning composition comprising the surfactant blends according to the present invention show a higher value, thereby indicating a better cleaning effect compared to traditional alkali-based formulation or with a surfactant alone.

1. A method for reducing hydrophobic soil from a textile comprising
(I) treating the textile with a cleaning composition comprising
(i) at least two surfactants selected from
(a) nonionic surfactants of general formula (I)
R₁—O-(A)ₓ-(B)_{y1}-(A)_{z}-(B)_{y2}—R₂ (I),
wherein
R₁ is selected from linear or branched, substituted or unsubstituted C₁-C₂₂ alkyl,
R₂ is selected from H and linear or branched, substituted or unsubstituted C₁-C₂₂ alkyl,
A is CH₂—CH₂—O,
B is CH₂—CHR₃—O, wherein R₃ is selected from H and a linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1; and/or
(b) alkylpolyglycosides of general formula (II) 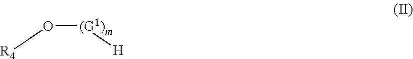
wherein
R₄ is a linear or branched, substituted or unsubstituted C₆ to C₃₀ alkyl,
G¹ is a monosaccharide residue having 5 or 6 carbon atoms, and
m is on average in the range of 1 to 10

2. The method according to claim 1, wherein R₄ is a linear, unsubstituted C₆ to C₁₄ alkyl, G¹ is selected from glucose, xylose, arabinose, rhamnose, and mixtures thereof and m is in the range of 1.05 to 2.5.

3. The method according to claim 1, wherein the textile is made of fibers selected from the group of natural fibers and synthetic fibers.

4. The method according to claim 3, wherein the textile is made of synthetic fibers selected from the group of polyurethane fibers, polyester fibers, polyolefins, polyamide fibers, and mixtures thereof.

5. The method according to claim 1, wherein the cleaning composition is free of alkali metal hydroxide.

6. The method according to claim 1, wherein the cleaning composition comprises at least two surfactants selected from
(a1) a first nonionic surfactant of formula (I); and
(a2) a second nonionic surfactant of formula (I)
where (a1) is different from a2; and
wherein the weight ratio of (a1) to (a2) is in the range of 1:1 to 2:1.

7. The method according to claim 6, wherein for (a1) the first nonionic surfactant of general formula (I) R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2.

8. The method according to claim 7, wherein for (a2) the second nonionic surfactant of general formula (I) R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4.

9. The method according to claim 1, wherein the cleaning composition comprises at least three surfactants selected from
(a1) a first nonionic surfactant of formula (I),
(a2) a second nonionic surfactant of formula (I); and
(a3) a third nonionic surfactant of formula (I)
where the nonionic surfactants (a1), (a2) and (a3) are different from each other; and
wherein the weight ratio of said nonionic surfactants (a1) to (a2) to (a3) is in the range of 1:1:1 to 1:3:3.

10. The method according to claim 9, wherein for the third nonionic surfactant of formula (I), R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1.

11. The method according to claim 1, wherein the cleaning composition comprises at least two surfactants selected from
(a1) nonionic surfactant of formula (I); and
(b1) an alkylpolyglycoside of general (II)
wherein the weight ratio of (a1) to (b1) is in the range of 1:1 to 4:1.

12. The method according to claim 11, wherein for (b1) an alkylpolyglycoside of general formula (II) R₄ is a linear or branched, unsubstituted C₁₀ to C₁₄ alkyl, G¹ is a monosaccharide residue having 6 carbon atoms, m is on average in the range of 1.05 to 2.5.

13. The method according to claim 1, wherein the cleaning composition further comprises at least one additive selected from chelating agents, enzymes, builders, bleaching agents, fragrances, and fillers.

14. (canceled)

15. The method according to claim 1 wherein the hydrophobic soil is oil and/or grease.

16. The method according to claim 1 wherein the textile is selected from towel and wipes.

17. A cleaning composition comprising at least two surfactants selected from
(a1) a first nonionic surfactant of formula (I), wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2; and
(a2) a second nonionic surfactant of formula (I), wherein R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4; and
where said nonionic surfactant (a1) is different from a2.

18. The cleaning composition according to claim 17, wherein the weight ratio of the first nonionic surfactant (a1) to the second nonionic surfactant (a2) is in the range of 1:1 to 2:1.

19. A cleaning composition comprising at least three surfactants selected from
(a1) a first nonionic surfactant of formula (I) wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2,
(a2) a second nonionic surfactant of formula (I), wherein R₁ is linear or branched, unsubstituted C₆-C₁₆ alkyl, x is an integer in the range of 4 to 10, y₁ is 0, y₂ is 0, z is 0, R₂ is H, and wherein the sum of x+y₁+z+y₂ is at least 4; and
(a3) a third nonionic surfactant of formula (I), wherein R₁ is linear or branched, unsubstituted C₈-C₁₆ alkyl, x=is 0 to 10, y₁=1 to 10, z=0-6, y₂=0, R₂ is H, R₃ is C₁-C₂ alkyl and wherein the sum of x+y₁+z+y₂ is at least 1; and
where the nonionic surfactants (a1), (a2) and (a3) are different from each other.

20. The cleaning composition according to claim 19, wherein the weight ratio of said nonionic surfactants (a1) to (a2) to (a3) is in the range of 1:1:1 to 1:3:3.

21. A cleaning composition comprising at least two surfactants selected from
(a1) nonionic surfactant of formula (I) wherein R₁ is branched, unsubstituted C₁₂-C₁₄ alkyl, x is an integer in the range of 2 to 10, y₁ is 0, y₂ is 0, z is 0, R₂ is H, and wherein the sum of x+y₁+z+y₂ is at least 2; and
(b1) an alkylpolyglycoside of general (II), R₄ is a linear or branched, unsubstituted C₁₀ to C₁₄ alkyl, G¹ is a monosaccharide residue having 6 carbon atoms, m is on average in the range of 1.05 to 2.5.

22. The cleaning composition according to claim 21, wherein the weight ratio of nonionic surfactants (a1) and the alkylpolyglycoside (b1) is in the range of 1:1 to 4:1.
